(19) United States
(12) Patent Application Publication
(10) Pub. No.: US 2014/0136312 A1
(43) Pub. Date: May 15, 2014

(54) LOCATION-BASED CONTENT DELIVERY

(71) Applicant: COX COMMUNICATIONS, INC., Atlanta, GA (US)

(72) Inventors: Asheesh Saksena, Warren, NJ (US); Radhakrishnan Gopinath, Alpharetta, GA (US); Pujan Roka, Alpharetta, GA (US)

(73) Assignee: COX COMMUNICATIONS, INC., Atlanta, GA (US)

(21) Appl. No.: 13/801,247

(22) Filed: Mar. 13, 2013

Related U.S. Application Data
(60) Provisional application No. 61/724,441, filed on Nov. 9, 2012.

(51) Int. Cl. G06Q 30/02

(52) U.S. Cl. CPC G06Q 30/0261; H04L 43/00
USPC 705/14.39; 709/224

(57) ABSTRACT

This disclosure describes systems and methods related to location-based content delivery. Data from one or more indoor position system (IPS) beacons may be received. A location for a user device may be determined based at least in part on the received data. Content, such as advertisements, may be retrieved based at least in part on the location of the user device. A notification generated based at least in part on the content may be transmitted to the user device.

### RELATED APPLICATIONS

This application claims priority to U.S. Provisional Patent Application No. 61/724,441, entitled “Location Based Content Delivery,” filed on Nov. 9, 2012, the contents of which are incorporated by reference herein in their entirety.

### TECHNICAL FIELD

Embodiments of this disclosure relate generally to content delivery, and more particularly, to location based content delivery to mobile devices.

### BACKGROUND

Advertisers attempt to reach customers through email and website advertisements. However, shoppers often do not remember the advertisements while they are out shopping or may have forgotten to bring the advertisement or coupon to the retail location. Merchants often attempted to reach customers during the shopping experience through public announcement systems, signage or other means for attracting the shoppers' attention, such as flashing lights or product demonstrations at certain locations within a store where discounts are offered in the retail store.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1A depicts an illustrative system architecture for location based content delivery, in accordance with one or more embodiments of the disclosure.

FIG. 1B depicts a more detailed system architecture for location based content delivery, in accordance with one or more embodiments of the disclosure.

FIG. 1C depicts a more detailed system architecture for location based content delivery, in accordance with one or more embodiments of the disclosure.

FIG. 2A depicts a block diagram of a user device configuration for location based content delivery, in accordance with one or more embodiments of the disclosure.

FIG. 2B depicts a block diagram of a location aware content server configuration for location based content delivery, in accordance with one or more embodiments of the disclosure.

FIG. 3A depicts an illustration of a user device displaying a sample output for location based content delivery, in accordance with one or more embodiments of the disclosure.

FIG. 3B depicts an illustration of a user device displaying a sample output for location based content delivery, in accordance with one or more embodiments of the disclosure.

FIG. 4 depicts an illustration of a user device displaying a sample output for location based content delivery, in accordance with one or more embodiments of the disclosure.

FIG. 5A depicts a flow diagram of a method for location based content delivery, in accordance with one or more embodiments of the disclosure.

FIG. 5B depicts a flow diagram of a method for location based content delivery, in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein may be directed to location based content delivery. Wireless network providers and merchants may manage and monetize notifications transmitted to user devices capable of wireless communication to specifically target devices based upon device location and preferences indicated by a user associated with the device. Merchants may control the number and frequency of the delivery of targeted messages (notifications, advertisements, coupons, etc.) to the user devices, which may facilitate efficient delivery of content to customers at a retail locations, and more so, to customers at specific locations within a retail location. Further, certain embodiments described herein may facilitate the efficient management of advertising budgets by controlling the amount of advertising budget spent on such notifications. While various embodiments and features of the present disclosure are described in the context of a single merchant or retail site, it will be appreciated that the solutions described herein may equally be applied to malls, shopping districts, entertainment venues, festivals, sporting arenas, etc., where a plurality of merchant are co-located.

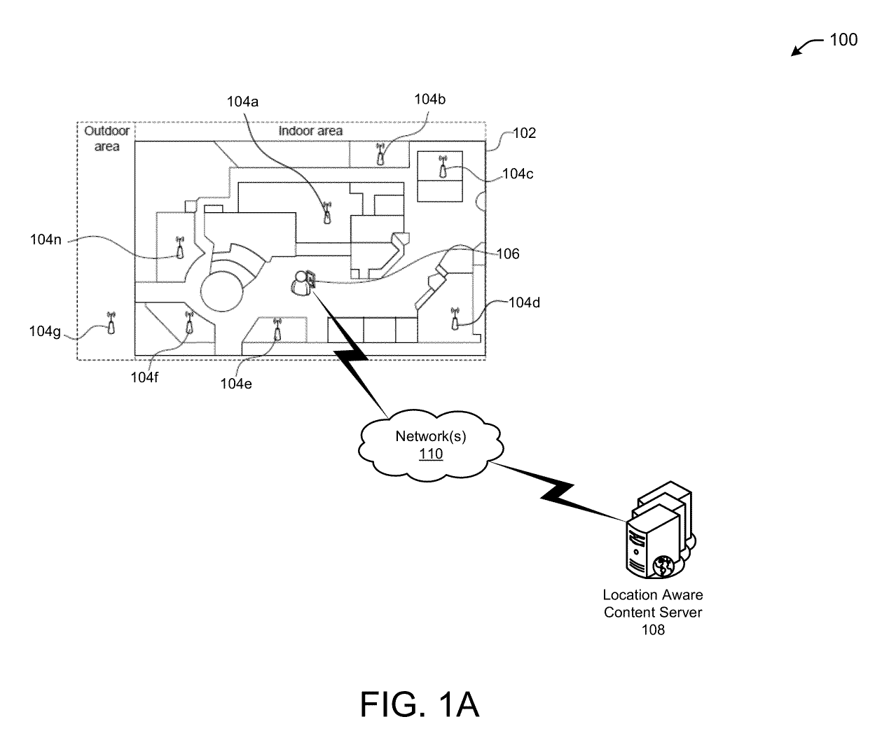

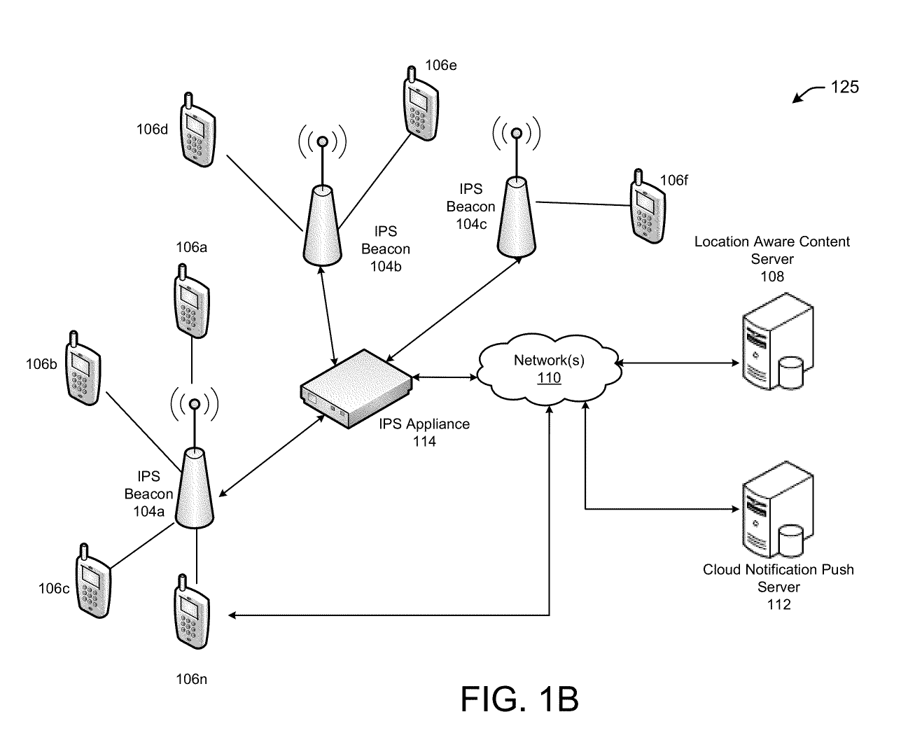

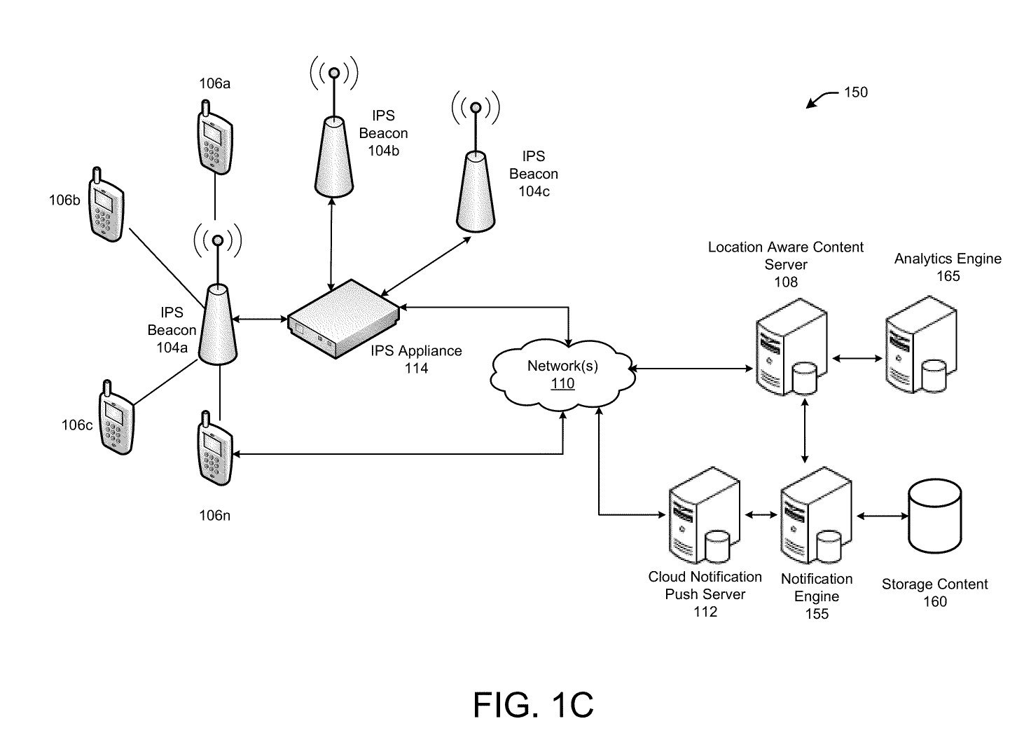

FIG. 1A depicts an illustrative system architecture for location based content delivery, in accordance with one or more embodiments of the disclosure. A location based content delivery system 100 may include an indoor positioning system (IPS) that may define an IPS local coverage area 102. The IPS local coverage area 102 may include indoor and/or outdoor locations. Examples of IPS local coverage areas 102 where the IPS may be used include, but are not limited to, hospitals, hotels, sports arenas, airport terminals, outdoor festivals, and shopping malls. Each IPS location may be a physical location in the IPS local coverage area 102. Examples of IPS locations may include, but are not limited to, businesses (e.g., stores, concession stands, and retail kiosks), facilities (e.g., restrooms, elevators, security offices, clinics, and information kiosks), and defined areas (e.g., seating sections, food courts, entrances/exits, gates, lobbies, and casinos). Although described in the context of an indoors system, the IPS may have utility in outdoor and/or mixed indoor/outdoor local coverage areas. For example, IPS may be useful in locations where the lack of an adequate number of nearby cellular towers, and/or where structures may block or limit GPS signals and/or cellular signals to limit the availability or reduce the accuracy of position information provided by GPS and/or other location services. In various embodiments, the IPS may include outdoor IPS beacons 104 to create geo-fencing applications.

The IPS local coverage area 102 may be covered by a number of IPS beacons 104a-104n (collectively referred to as 104) which may be located within or proximate to the IPS local coverage area 102. The IPS beacons 104 may be linked to (and may be supplied by) an IPS provider. Each IPS beacon 104 may be configured with a unique identifier and, optionally, additional information about the IPS beacon 104. Generally, the IPS may include IPS beacons 104 to provide IPS signal coverage of the entire IPS local coverage area 102. The IPS beacons 104 may permit the IPS to determine the position of a user device 106 within the IPS local coverage area 102. The precision of the position determined by the IPS may be a function of the number of IPS beacons 104 used.

One purpose of the IPS beacons 104 may be to transmit an IPS identifier (IPS ID) that is used in determining the location of the user device 106. The IPS beacons 104 may be radio frequency transmitters/transceivers operating on frequencies commonly receivable by a mobile computing device. Examples of suitable frequency ranges include, but are not limited to, the frequency ranges of radio frequency identification (RFID), Wi-Fi, and Bluetooth communications. Further, the IPS beacons 104 may transmit signals that are receivable using one or more application program interfaces (APIs) of a mobile computing device 106. Examples of suitable IPS beacons 104 may include, but are not limited to, wireless access points, RFID transponders, and Wi-Fi or Bluetooth-enabled devices such as a laptop or other computing device.

The IPS ID may uniquely identify the IPS beacon 104 within the IPS local coverage area 102. Examples of suitable unique identifiers may include, but are not limited to, Media Access Control (MAC) addresses, service set identifier (SSID), custom identifiers added to the configuration of the local radio frequency transmitter, and various combinations thereof. In various embodiments, the IPS beacon 104 configuration may include additional IPS information that may be transmitted by the IPS beacon 104. Examples of the additional IPS information may include, but are not limited to, an IPS local coverage area identifier, an IPS subscriber identifier, and other information about the IPS local coverage area 102, the IPS subscriber, and/or the IPS beacon 104. In some embodiments, the additional configuration information may be transmitted with the IPS ID. In other embodiments, the additional configuration information may be transmitted in response to a request from the user device 106.

In various embodiments, the IPS may offer value added services to IPS subscribers. IPS subscribers may be businesses at the IPS local coverage area 102 which may contract with the IPS provider for the ability to interact with user devices 106 subscribed to the IPS. In various embodiments, an IPS beacon 104 may be associated with a corresponding IPS subscriber. In other embodiments, the IPS subscriber transmitter may be a new IPS beacon 104 dedicated to the IPS subscriber and added to the IPS. In various embodiments, the IPS subscriber transmitter may be located within or proximate to the physical location of the corresponding IPS subscriber.

An IPS client on a user device 106 may communicate with a location aware content server 108 accessible over a network 110 (e.g., a local area network or a wide area network). The location aware content server 108 may perform functions to facilitate location based content delivery, such as determining a relative location of a user device 106 in an IPS local coverage area 102. The location aware content server 108 may use a positional reference system (e.g., a coordinate system or a grid) that corresponds to the IPS local coverage area 102. The physical position of the IPS beacon 104 may be associated with a location in the positional reference system and linked using an IPS ID of the IPS beacon 104. In various embodiments, a graphical representation of the IPS local coverage area 102 (e.g., a map) may be associated with and linked to the positional reference system. Once the IPS beacon 104 is linked to the positional reference system, the IPS may be able to provide position information by determining the relative position of the IPS client to the IPS beacon 104.

Once a map is linked to the positional reference system, the IPS may be able to provide a graphical representation of the position of the IPS client relative to the IPS beacon 104. In various embodiments, paths representing common areas (e.g., hallways, corridors, stairways, or elevators) that connect IPS locations may be associated with the positional reference system. Once paths are linked to the positional reference system, the IPS may be able to provide route information to inform the user of the user device 106 executing the IPS client how to reach a selected IPS location from the current position of the IPS client. In various embodiments, the IPS also provides navigation services that update the position of the IPS client along the route and optionally provides “turn-by-turn” directions as the IPS client reaches a path junction (i.e., a point where two or more paths meet). In some embodiments, the location based content delivery system may send notification of a sale of a particular item or a sale in a particular store. The notification may include directions presented to the user by the IPS client. In some embodiments, the notification may indicate that a sale or event may be limited in supply or only within a limited time frame. For example, a store may offer a 20% discount on children's shoes for the next 30 minutes or $10 off the next 20 pairs of shoes sold.

FIG. 1B depicts a more detailed system architecture for location based content delivery, in accordance with one or more embodiments of the disclosure. In brief overview, one or more user devices 106a-106n (collectively 106) may communicate with one or more IPS beacons 104a, 104b, 104c (collectively 104). The one or more IPS beacons 104 may communicate with an IPS appliance 114. The IPS appliance 114 may communicate with a location aware content server 108 over one or more networks 110. One or more user devices 106 may also communicate with a cloud notification push server 112 over one or more networks 110.

For the purposes of this discussion, the user device 106 may include, but is not limited to, a tablet computer, a notebook computer, a netbook computer, a personal digital assistant (PDA), a cellular telephone, a smart phone, a digital reader, gaming device, or any other suitable electronic device with communicative, processing, and storage capabilities. In one aspect, the user device 106 may be a portable or mobile electronic device. The user devices 106 may communicate with one or more IPS beacons 104 over wireless communication protocols, such as Wi-Fi or Bluetooth. The user devices 106 may transmit data associated with the user device 106 and/or associated with the user of the user device 106.

The IPS beacon 104 may receive information from one or more user devices 106. The IPS beacon 104 may communicate with the IPS appliance 114. In some embodiments, the IPS beacon 104 may transmit data received from one or more user devices 106. The IPS beacon 104 may also transmit data associated with itself, such as an IPS beacon ID. In some embodiments, the IPS appliance 114 may determine the location of a user device 106 based upon, at least in part, data received from one or more beacons 104. In other embodiments, the IPS beacon 104 may communicate with one or more location aware content servers 108. The location aware content server 108 may determine the location of a user device 106 based upon, at least in part, the data received from one or more beacons 104. In some embodiments, the location aware content server 108 may determine the location of a user device 106 based upon, at least in part, the data received from one or more IPS appliances 114. The data received from the one or more IPS appliances 114 may include data associated with one or more user devices 106 and/or data associated with one or more beacons 104.

The IPS appliance 114 may communicate with one or more location aware content servers 108. The location aware content server 108 may determine a location of one or more user devices 106, may identify one or more users associated with the user device 106, may determine a location of the user device 106, and may determine content associated with the determined location of the user device 106. In some embodiments, the content may include, but are not limited to, advertisements, coupons, messages, games, information, notifications, maps, directions, or other data that may be included in targeted messages to users. In some embodiments, the location aware content server 108 may communicate with a cloud notification push server 112. The location aware content server 108 may transmit data identifying the content and data associated with the user device 106. The cloud notification push server 112 may generate messages or notifications associated with the identified content and may transmit the messages or notifications to the user device 106 over one or more networks 110. The functionality of 108, 112, and 114 may be centralized at a single computing device or server, or distributed among multiple devices as desired.

FIG. 1C depicts a more detailed system architecture for location based content delivery, in accordance with one or more embodiments of the disclosure. FIGS. 1B and 1C are similar in many respects, thus only the differences are discussed in further detail. In brief overview, one or more user devices 106 may communicate with one or more IPS beacons 104. The one or more IPS beacons 104 may communicate with an IPS appliance 114. The IPS appliance 114 may communicate with a location aware content server 108 over one or more networks 110. One or more user devices 106 may communicate with a cloud notification push server 112 over one or more networks 110. The cloud notification push server 112 (also known as a “push server”) may communicate with a notification engine 155. The notification engine 155 may communicate with one or more storage devices 160 for storing the content, which may include but are not limited to advertisements, coupons, messages, games, or other content. The location aware content server 108 may communicate with an analytics engine 165.

The location aware content server 108 may receive information associated with the one or more user devices 106 and information associated with one or more IPS beacons 104 from the IPS appliance 114. The location aware content server 108 may, in some embodiments, determine a location of a user device 106 based upon information received from the IPS appliance 114. In some embodiments, the location aware content server 108 may use information associated with the IPS local coverage area 102, such as a map of the area or measurements of the IPS local coverage area 102, location of retail stores, or other identifying information about the IPS local coverage area 102. The location aware content server 108 may transmit information received from the IPS appliance 114 and/or information generated by the location aware content server 108 to an analytics engine 165. The analytics engine 165 may process or analyze the received data. In some embodiments, the analytics engine 165 may create reports, such as heat maps, dwell times associated with a particular user device 106, density maps, and other types of information based upon the information received from the location aware content server 108. The analytics engine 165 may transmit the processed data or reports to the location aware content server 108. In some embodiments, the location aware content server 108 may provide the processed data or the reports to a merchant or IPS subscribers. The processed data or reports may be provided to a merchant or an IPS subscriber through a web portal, emails, texts, or other types of communication.

The location aware content server 108 may communicate with the notification engine 155. The notification engine 155 may obtain relevant content (e.g., an advertisement or coupon) based upon the location data and/or processed data or reports received from the location aware content server 108. In some embodiments, the notification engine 155 may retrieve or obtain content from a storage device 160 associated with the notification engine 155. The notification engine 155 may then generate a notification based upon the location of a user device 106 and a relevant content and transmit the notification to the cloud notification push server 112. The cloud notification push server 112 may transmit the notification to the user device 106. The notification may be presented to a user of the user device 106. For example, a user may respond to a notification message containing a link to a coupon by clicking on a hyperlink in the notification to obtain the coupon for redemption. As will be appreciated by those in the art, the functionality of the devices, appliances and servers discussed herein (e.g., items 108, 112, 114, 155, 160, 165) may be combined or distributed among one or more devices, appliances and servers in a manner other than described herein, such as with a centralized server, as may be desired.

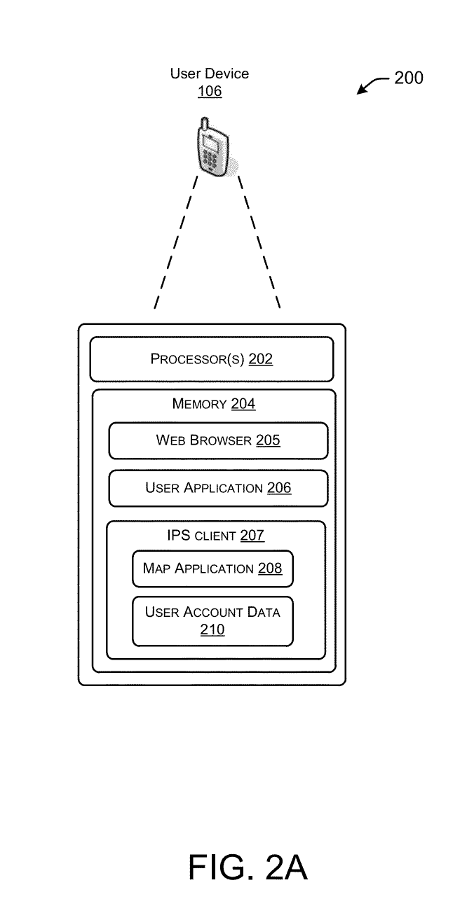

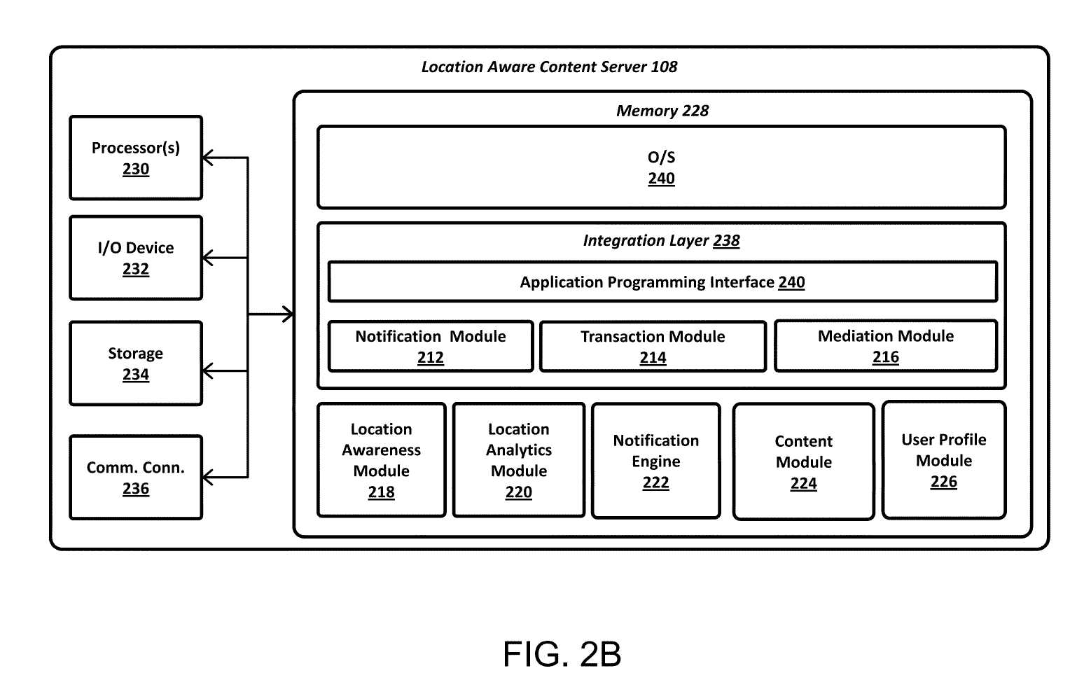

FIG. 2A depicts an illustrative diagram of a user device configuration for location based content delivery, in accordance with one or more embodiments of the disclosure. The user device configuration 200 may include one or more user device(s) 106 that may be used by one or more users.

Each of the user device(s) 106 may include at least one memory 204 and one or more processing units (or processor(s)) 202. The processor(s) 202 may be implemented as appropriate in hardware, software, firmware, or combinations thereof. Software or firmware implementations of the processor(s) 202 may include computer-executable or machine-executable instructions written in any suitable programming language to perform the desired functions. Similarly, hardware implementations of the processor(s) 202 may be configured to execute computer-executable or machine-executable instructions to perform the various functions described.

The memory 204 may store program instructions that are loadable and executable on the processor(s) 202, as well as data generated during the execution of these programs. Depending on the configuration and type of user device 106, the memory 204 may be volatile (such as random access memory (RAM)) and/or non-volatile (such as read-only memory (ROM), flash memory, etc.). The user device 106 may also include additional removable storage and/or non-removable storage (not shown) including, but not limited to, magnetic storage, optical disks, and/or tape storage. The disk drives and their associated computer-readable media may provide non-volatile storage of computer-readable instructions, data structures, program modules, and other data. In some implementations, the memory 204 may include multiple different types of memory, such as static random access memory (SRAM), dynamic random access memory (DRAM), and/or ROM.

The memory 204 and/or the additional storage (not shown), removable and/or non-removable, are all examples of computer-readable storage media. For example, computer-readable storage media may include volatile and/or non-volatile, removable and/or non-removable media implemented according to any method or technology for storage of information such as computer-readable instructions, data structures, program modules, and/or other data. Further, the user device(s) 106 may each further include additional components that are not depicted such as, for example, communications connection(s), input/output (I/O) devices, and so forth.

A web browser 205 may be loaded into the memory 204. The web browser may be invoked by one or more user applications 206 or may be used to display or otherwise present content to a user of a user device 106.

One or more user applications 206 may be loaded into the memory 204. The user application 206 may be any application capable of facilitating the display of, or otherwise presenting content, the user of the user device 106 based upon the location of the user device 106. For example, the user application 206 may present content such as advertisements or coupons to users through user devices 106. The user application 206 may include, but is not limited to, a web-based browser application. For example, the location based content delivery may be provided to the user through the web browser 205. In some embodiments, the location based content delivery may be provided to the user through a dedicated software application, such as an IPS client 207. In some embodiments, a user device 106 may include a data store for storing information associated with location based content delivery. The dedicated software application may be capable of creating, storing and using credentials to authenticate the user device 106 with the location aware content server 108. The dedicated software application may be capable of processing data and determining the location of the user device 106 in the context of an IPS local area coverage 102.

The IPS client 207 may communicate with the location aware content server 108, IPS beacons 104, IPS appliance 114, push server 112, notification engine 155, analytics engine 165, and other components as required to achieve the functionality described herein and that which is inherent to in the present description. In some embodiments, the IPS client 207 may obtain indoor positioning information and any available value added services. For example, an IPS client 207 may include a map application 208 which may display the location of the user device 106 relative to an IPS local coverage area 102. In some embodiments, the map application 208 may determine a location of the user device 102 in an IPS. Communications between the user device 106 and the location aware content server 108 may be in the form of requests and responses; however, in some embodiments, communications may be in the form of broadcasts. Any of the requests or responses described herein may be made up of one or more messages, as necessary or desired. Further, multiple requests or responses may be combined into a single message when desired or practicable. In some embodiments, IPS client 207 may include user account data 210. User account data 210 may include a username and password associated with the user device 106 and the location aware content server 108. In some embodiments, the user account data 210 may include histories of previous interactions with the location aware content server 108, prior content that was presented to the user, previous location information, and other information associated with the user device 106.

In various embodiments, the IPS client 207 may be invoked by a user of the user device 106. In other embodiments, an IPS-enabled map application 208 may be invoked on the user device 106 when entering an indoor location with a specific IPS ID. In some embodiments, a GPS-enabled map application may invoke the indoor positioning system based on the current position of the user device 106. For example, the GPS-enabled map application may invoke the indoor positioning system when the user device 106 is located at a particular latitude and longitude. The IPS-enabled map application 208 may query the location aware content server 108 based upon a received IPS ID associated with an IPS beacon 104 to locate the corresponding indoor map, and may display the location of the IPS beacon 104 associated with the IPS ID on the map.

Now referring to FIG. 2B, an illustrative diagram of a location aware content server 108 configuration for location based content delivery, in accordance with one or more embodiments of the disclosure, is depicted. The location aware content server 108 may include at least one memory 228 and one or more processing units (or processor(s)) 230. The processor(s) 230 may be implemented as appropriate in hardware, software, firmware, or combinations thereof. Software or firmware implementations of the processor(s) 230 may include computer-executable or machine-executable instructions written in any suitable programming language to perform the various functions described. Similarly, hardware implementations of the processor(s) 230 may be configured to execute computer-executable or machine-executable instructions to perform the various functions described.

The memory 228 may store program instructions that are loadable and executable on the processor(s) 230, as well as data generated during the execution of these programs. Depending on the configuration, the memory 228 may be volatile, such as random access memory (RAM), and/or non-volatile, such as read-only memory (ROM), flash memory, etc.

Turning now to the contents of the memory 228, the memory 228 may include any number of suitable memory devices, such as caches, read-only memory devices, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, magnetic storage devices, removable storage devices (e.g., memory cards, etc.), and/or non-removable storage devices. As desired, the memory 228 may include internal memory devices and/or external memory devices in communication with systems 100, 125, 150.

The memory 228 may store data, executable instructions, and/or various program modules utilized by the processor 230. Examples of data that may be stored by the memory 228 include data files and any number of suitable program modules and/or applications that may be executed by the processor 230, such as, but not limited to, an operating system (O/S) 240, a notification module 212, a transaction module 214, a mediation module 216, a location awareness module 218, a location analytics module 220, a notification engine module 222, an advertisements module 224, and/or user profile module 226. Each of these modules may be implemented as individual modules or, alternatively, one or more of the modules may perform all or at least some of the functionality associated with the other modules. In certain embodiments, these modules may be stored as firmware in a read-only memory, thereby making it more difficult for the functions described herein to be tampered with or disabled.

The I/O devices 232 may include, but are not limited to, a keyboard, a mouse, a pen, a voice input device, a touch input device, a display, a camera or imaging device, speakers, or a printer.

The storage 234 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices.

The memory 228 and the storage 234, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The one or more communication connections 236 may allow the location aware content server 108 to communicate with other devices, such as the cloud notification push server 112 or one or more user devices 106, databases, and various other devices that may exist on the one or more networks 110. The communication connections 236 may include various communication interfaces or components that may enable the location aware content server 108 to communicate with other devices, such as one or more user devices 106. Such interfaces or components may include Short Message Service (SMS) text messaging, Internet web pages, or other interfaces that may allow communication from the location aware content server 108 using Bluetooth®, a digital radio network, a cellular network (e.g., third generation and/or fourth generation), a Wi-Fi network, a satellite network, etc.

One or more data stores (not pictured) may store lists, arrays, databases, flat files, etc. In some implementations, the data stores may be stored in memory external to the location aware content server 108 but may be accessible via the one or more networks 110, such as with a cloud storage service. The data stores may store information that may be associated with location based content delivery as described herein. Such information may include, but is not limited to, customer profiles, user device 106 profiles, shopping history, stores visited, transaction histories, and the like.

In addition to or alternative to the memory 228, other embodiments may include one or more suitable computer-readable media that may be provided for storing computer-executable instructions such as those stored in the memory 228. One or more processing devices, such as the processor(s) 230, may execute such computer-executable instructions to facilitate the location based content delivery, as described above in association with the modules in the memory 228. As used herein, the term “computer-readable medium” may describe any form of suitable memory or memory device for retaining information in any form, including various kinds of storage devices (e.g., magnetic, optical, static, etc.). Indeed, various embodiments of the disclosure may be implemented in a wide variety of suitable forms.

The operating system 240 may include a suitable module or application that facilitates general operation of the location aware content server 108, as well as the execution of other program modules illustrated in the memory 228.

The integration layer 238 may include the application programming interface (API) 240, the notification module 212, the transaction module 214, and the mediation module 216.

The API 240 may be used as an interface by one or more modules to communicate with each other and to create the user-facing experience.

The notification module 212 may perform a number of functions to trigger notification to the user device 106 based on the notification content (e.g., advertisements) supplied by the notification engine 222. The notification module 212 may generate a notification which may include content identified by the notification engine 222 and transmit the notification. In some embodiments, the notification module 212 may transmit the notification to the user device 106. In some embodiments, the notification module 212 may transmit the notification to the push server 112.

The transaction module 214 may perform a number of functions to manage the user interface and logic for presenting content and tracking user responses and/or interactions with said content, such as ad impressions, click-throughs, redemptions, routes followed, etc. For example, the transaction module 214 may pass transaction data (e.g., advertisement impressions and click-throughs) to the mediation module 216. The transaction module 214 may track the number of coupons and transmittal of coupons to user devices 106. In some embodiments, the transaction module 214 may process transaction data, such as advertisement impressions and click-throughs, as well as whether a user device 106 accessed a hyperlink included in a notification to the user device 106. The transaction module 214 may track the transaction of a coupon based on transaction information received from the merchant or IPS subscriber received. In some embodiments, the transaction module 214 may manage the user interface for redeeming content. For example, the hyperlink transmitted to the user device 106 in the notification may direct the user device to a website or page that contains the content identified by the notification engine 222. The transaction module 214 may generate the page associated with the hyperlink based upon the content identified by the notification engine 222. In some embodiments, the transaction module 214 may generate or render the page based upon, at least in part, information associated with the user device 106. For example, the transaction module 214 may determine that the user device 106 is a smartphone and render a page with a resolution for a smartphone. In some embodiments, the page may include elements permitting the user to select how to redeem or select options associated with the content. For example, the page may contain a button the user must select in order to generate a code to be presented to the retailer to be redeemed. The mediation module 216 may perform a number of functions to facilitate billing transactions and revenue management based upon, at least in part, the content (e.g., advertisements and coupons). For example, the mediation module 216 may receive transaction data (e.g., usage data) from the transaction module 214. In some embodiments, the mediation module 216 may receive processed transaction information from the transaction module 214. The mediation module 216 may obtain information associated with a merchant or IPS subscriber. For example, a merchant may specify a particular budget for an advertising campaign and the frequency of the notifications to user devices 106 as well as rates associated with each of the messages. The mediation module 216 may determine the cost associated with messages transmitted to user devices 106, calculate the budget associated with a merchant or IPS subscriber, or other billing or revenue management functions based upon, at least in part, transaction information received from the transaction module 214 and/or information obtained associated with the merchant or IPS subscriber.

The location awareness module 218 may perform a number of functions to facilitate identification of locations of one or more registered user devices 106. For example, the location awareness module 218 may receive information from one or more user devices 106, one or more IPS beacons 104, one or more IPS appliances 114, IPS local coverage area 102 information, map data associated with the local coverage area 102, and/or other information associated with IPS and the user device 106. In some embodiments, the location awareness module 218 may also receive GPS information associated with the user device 106. The location awareness module 218 may determine the location of one or more registered user devices 106 based upon, at least in part, the received information. The location awareness module 218 may transmit the location of the one or more registered user devices 106 to the respective user devices. In some embodiments, the location data may be collected and/or aggregated and presented to the merchant or IPS subscriber. In some embodiments, the location awareness module 218 may transmit the location of the one or more registered user devices 106 to the analytics engine for processing. In some embodiments, the location awareness module 218 may identify a map associated with the IPS local coverage area 102 and generate an indication of the location of a registered user device 106 to be transmitted to the user device 106. In some embodiments, the maps may be stored locally on the user device 106 and the location awareness module 218 may send a map identifier and instructions to indicate the location of the user device 106 relative to the identified map. In some embodiments, the location awareness module 218 may annotate the map or otherwise generate data so that the user device 106 may annotate a map with different types of information, such as time, traffic, and other information. The location analytics module 220 may perform a number of functions to facilitate processing of location information associated user devices 106 and an IPS, and may also facilitate the creation of analytical reports such as heat maps, dwell time, or density which may be based upon, at least in part, data received from one or more user devices 106, one or more IPS beacons 104, one or more IPS appliances 114, data associated with an IPS local coverage 102, and other information that may be associated with an IPS. The location analytics module 220 may receive information from multiple sources, such as any device in the location based content delivery system 100 and aggregate the received information. The location analytics module 220 may process the received information to generate reports or statistics associated with content delivery based upon an IPS. In some embodiments, the location analytics module 220 may store data associated with one or more user devices 106, IPS beacons 104, IPS appliance 114, and other devices in the location based content delivery system. The location analytics module 220 may process the information received from other modules, such as the transaction module 214. Such data may include device traffic data. In some embodiments, the location analytics module 220 may make recommendations or otherwise tailor the information sent to the user devices 106 based upon stored and/or processed information. The notification engine 222 may perform a number of functions to notify one or more user devices 106 of relevant content (e.g., advertisements, coupons) based on location data of the user devices 106. In some embodiments, the notification engine 222 may obtain preference information associated with an identified registered user device 106. In some embodiments, the notification engine 222 may receive the location data associated with the identified registered user device 106. The notification engine 222 may obtain content (e.g., advertisements and/or coupons) based upon, at least in part, the location of the user device 106 and the preferences associated with the user device 106. For example, a person may have specified that they are interested in content associated with pet accessories. The notification engine 222 may receive information identifying a registered user device 106 associate with that person. The notification engine 222 may obtain the preferences of the person (e.g., interest in pet accessories) using the identifying information associated with the registered user device 106. If the person walks by a pet store that sells pet accessories, the notification engine 222 may receive information indicating the location of the person (e.g., near or inside the pet store). The notification engine 222 may identify content based upon, at least in part, the preferences of the person and the current location of the person. Based at least on this information, the notification engine 222 may then identify an advertisement from the pet store for a discount on pet costumes. The notification engine 222 may generate a notification which may include the identified advertisement. The identified advertisement may be retrieved from the content module 224. The location aware content server 108 may transmit the notification to the user device 106. The integration layer 238 may retrieve the notification from this module and transmit it to the notification module 212. The notification module 212 may retrieve preferences associated with the user device 106 from the user profile module 226. Based upon the preferences specified, the notification module 212 may format the notification received from the notification engine 222 for the particular user device 106 and based upon, at least in part, the obtained user preferences. In some embodiments, the notifications may also be formatted using preferences specified by merchants or IPS subscribers for content delivery.

The content module 224 may perform a number of functions to facilitate management of content. For example, the content module 224 may receive content, such as advertisements, coupons, messages, games, videos, or other type of content. In some embodiments, the content module 224 may categorize the received content. For example, content may be categorized by type, such as advertisements, coupons, or messages. In some embodiments, the content may be categorized by other characteristics, for example, retailer type, product type, or service type. In some embodiments, the notification engine 222 may obtain relevant content from the content module 224.

The user profile module 226 may perform a number of functions to generate and maintain information associated with users of the user devices 106, such as opt-in information and notification preferences. In some embodiments, the user profile module 226 may maintain authentication credentials, such as a username and password, token, or license to identify or register the user device 106 to the location based content delivery system 100. In some embodiments, the user profile module 226 may receive user preference information, such as preferences associated with content, frequency of message deliveries, types of message deliveries, and/or an indication to participate in content delivery. For example, a person may specify they do wish to receive only content associated with menswear. The person may specify specific retail locations or merchants they wish to receive messages, frequency of the messages, message type (e.g., SMS message, email message, voice message) or other type of information associated with the preferences of the user.

In some embodiments, one or more computing devices of the location based content delivery system 100 may also include an authorization module (not pictured) and/or third party applications (not pictured). An authorization module may perform a number of functions to authorize communication between one or more modules through application programming interfaces (API) 240 to enable content delivery to user devices. User device 106 authentication, verification may be based upon, at least in part, data maintained by the user profile module 226. The third-party applications are applications that may leverage location based content provided by the platform and generate revenue from advertisement notifications and click-throughs. Although the modules above have been described in conjunction with a location aware content server 108, the modules may reside on any computing device of the location based content delivery system as described herein.

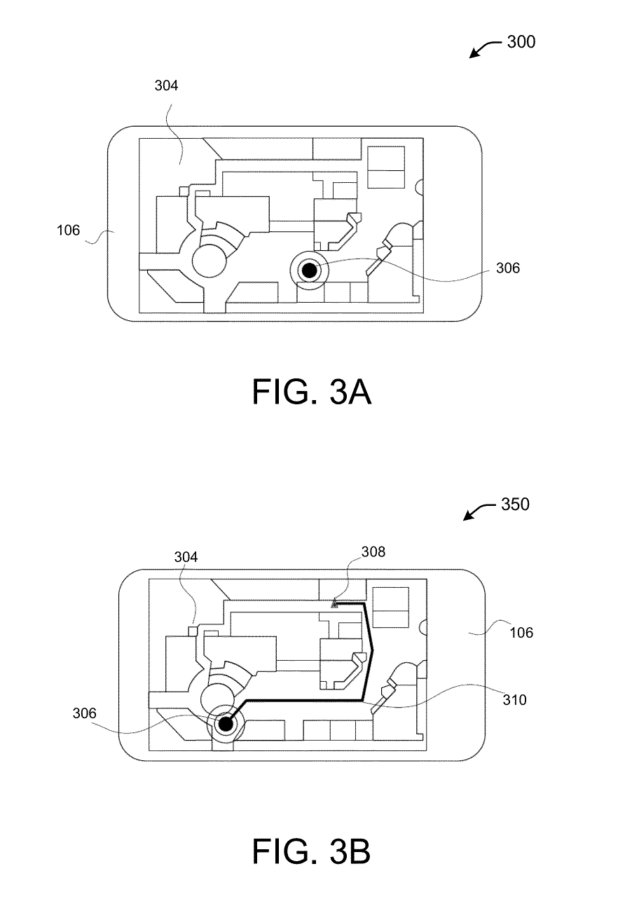

FIG. 3A depicts an illustrative screen shot 300 of a user device 106 displaying a sample output for location based content delivery, in accordance with one or more embodiments of the disclosure. The IPS client 207 of the user device 106 may display a sample output received from a location aware content server 108. The IPS client 208 may display the map 304 received from the location aware content server 108 on the user device 106. The position 306 of the user device 106 may be depicted in the map 304 as a symbol or a graphic.

FIG. 3B depicts an illustrative screen shot 350 of a user device 106 displaying a sample output for location based content delivery, in accordance with one or more embodiments of the disclosure. The IPS client 207 of a user device 106 may display a sample output received from a location aware content server 108. The IPS client 207 may display the map 304 received from the location aware content server 108 on user device 106. The position 306 of the user device 106 may be depicted in the map 304 as a symbol or a graphic. The position 308 of the destination (e.g., a retail store of a mall) may be displayed as a second symbol or graphic on the map 304 at the position indicated by the position information received from the location aware content server 108. In various embodiments, the first and second symbols or graphics may be visually distinguishable from each other by characteristics including, but not limited to, shape, size, and color. In the illustrated embodiment, the user device 106 may display the route 310 from the position of the user device 106 to the destination location as a path on the map 304.

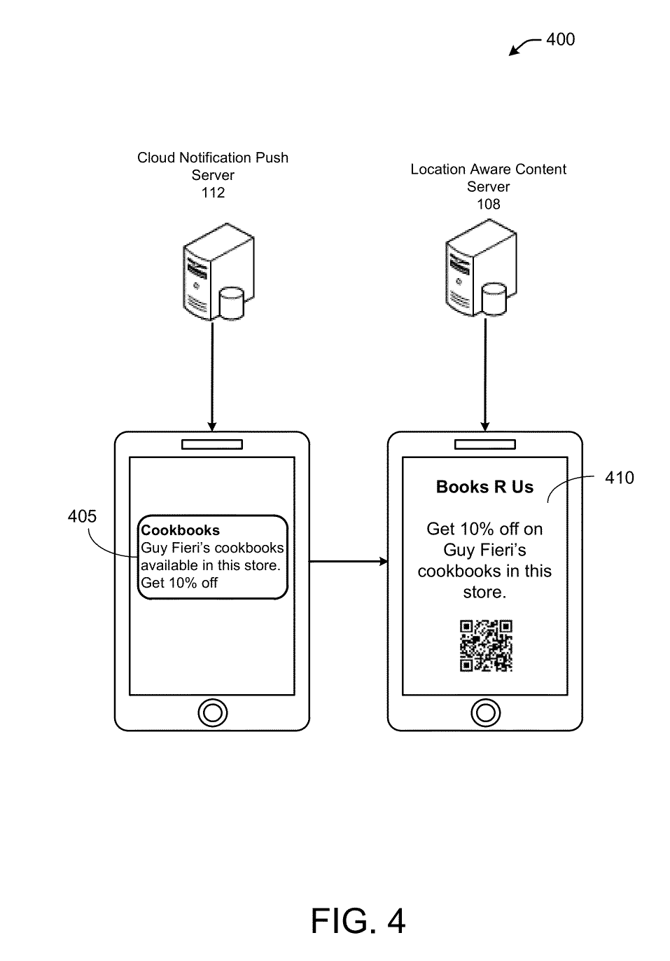

FIG. 4 depicts an illustration of an IPS client 207 displaying on a user device 106 a sample output for location based content delivery, in accordance with one or more embodiments of the disclosure. The cloud notification push server 112 may transmit a message to the IPS client 207 of the user device 106. The user device 106 may display a notification 405. The user may then select the notification 405, for example, by clicking in the notification, which may cause the user device 106 to display content 410 such as an advertisement or a coupon received from the location aware content server 108. In some embodiments, the IPS client 207 may send a request to the location aware content server 108 responsive to a user selecting a hyperlink to a coupon. Responsive to the request, the location aware content server 108 may transmit a response which may include the requested content (e.g., coupon). In some embodiments, the content may have been received by the user device 106 with the notification and stored in local memory. When the user requests the content, the user device 106 may retrieve the content stored in local memory of the user device 106. The functionality for location based content delivery system may be distributed among one or more computing devices as desired.

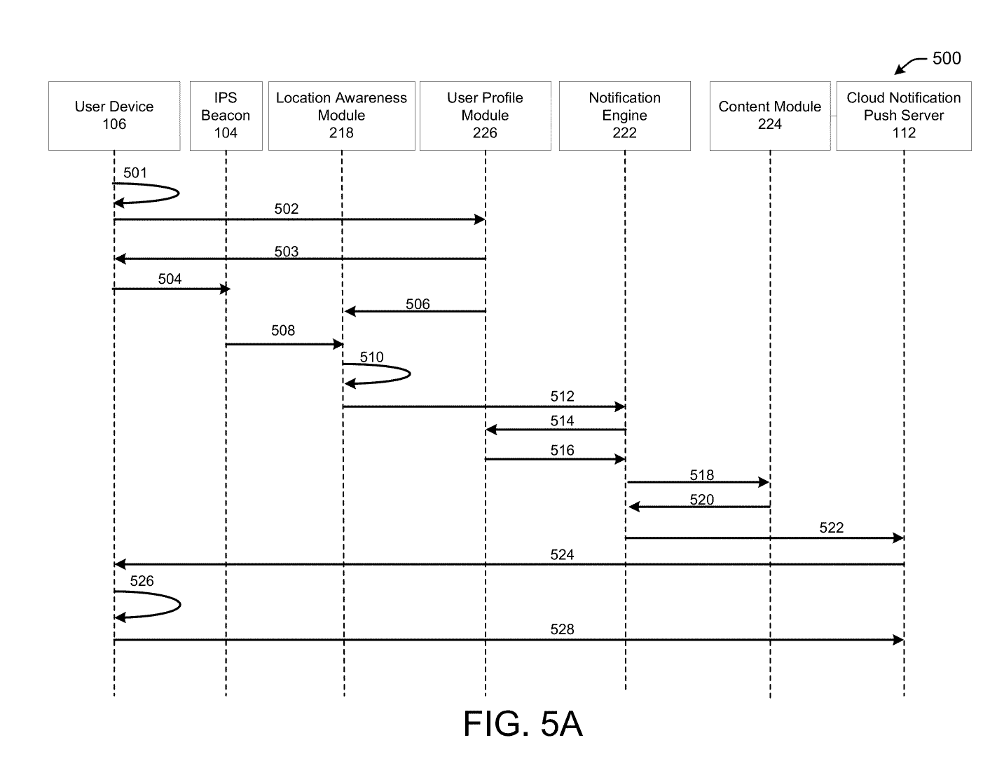

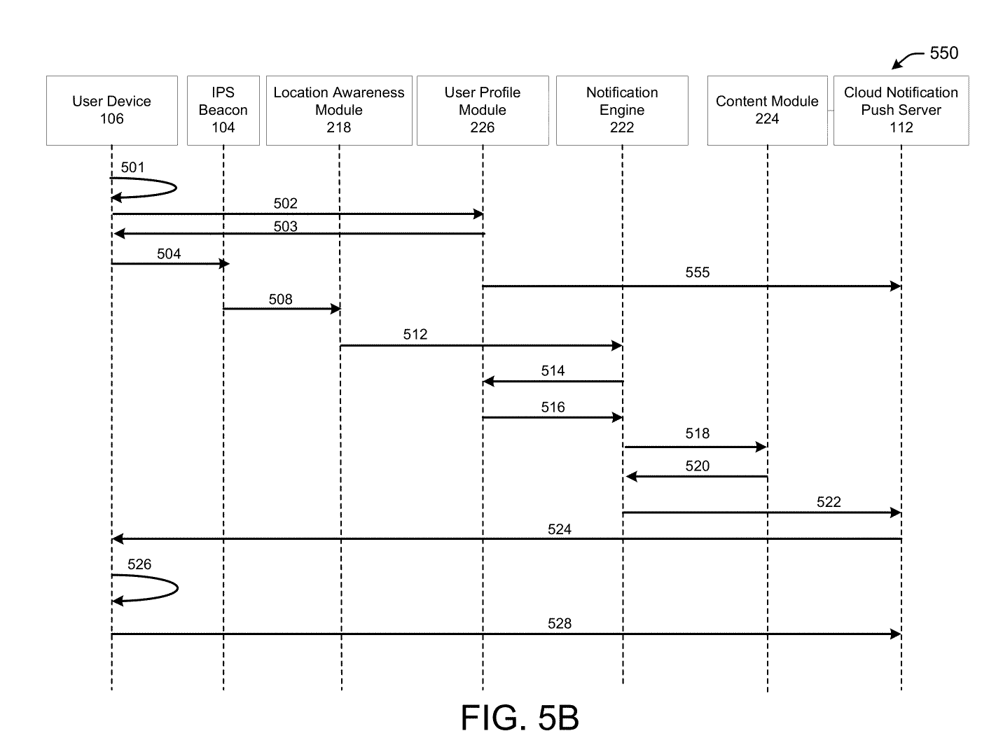

FIG. 5A depicts a flow diagram of a method for location based content delivery, in accordance with one or more embodiments of the disclosure.

In some embodiments, at exchange 501, a user device 106 may receive obtain a user application 206 for location based content delivery. In some embodiments, the IPS client 207 may be part of the user application 206. In some embodiments, the IPS client 207 may be a separate dedicated application that may need to be obtained by the user device 106. A user device 106 may obtain the user application 206 and/or the IPS client 207 in response to receiving a code. For example, a user device 106 may receive a Quick Response (QR) code or a barcode, near field communication (NFC), or receive an audible code. Responsive to receiving the code, the user device 106 may launch a web browser or an application to obtain the user application 206 and/or the IPS client 207.

In some embodiments, a user of the user device 106 may indicate he or she wishes to receive content, such as advertisements, coupons, maps, videos, messages, or other content. A user device 106 may receive certain data from the user such as information to establish a user account or otherwise request content. At exchange 502, the user device 106 may transmit the data to the user profile module 226. The data transmitted to the user profile module 226 may include a user device identifier such as a MAC address, user preferences, and information collected from the user to be authenticated by the location based content delivery system 100. The data may also include preferences for content, such as an indication of an interest in food, sports, specific stores, etc. In some embodiments, the user profile module 226 may determine if a user profile for the user exists. If a user profile does not exist, at exchange 503, the user profile module may transmit a generated user identifier or confirmation of creation of a profile for the user. At exchange 504, the user device 106 may transmit the newly generated device registration information to one or more IPS beacons 104 in the location based content delivery system. If a user profile exists, the user profile module 226 may update or otherwise modify the user profile based upon, at least in part, the data received from the user device 106.

In some embodiments, at exchange 506, the user profile module 226 may transmit the data associated with the user device 106 and/or the user to the location awareness module 218. For example, the user profile module 226 may notify the location awareness module 218 of the user device identifier indicating the user device 106 is registered or otherwise known to the location based content delivery system.

In some embodiments, at exchange 508, the location awareness module 218 may receive 508 data from one or more IPS beacons 104. For example, the IPS beacons 104 may determine, based upon the user device identifier, whether a user device 106 is connected or not connected. IPS beacons 104 may identify registered user devices 106 when they come in proximity to the IPS beacon 104. For example, a shopper may have registered his or her phone, and wireless access has been enabled on the phone. When the shopper walks by a particular store, an IPS beacon 104, which may be located inside or near the store, may identify the registered user device 106 and communicate with the user device. The IPS beacon 104 may obtain identifying information from the user device 106 such as a user device identifier (e.g., MAC address of the user device).

In some embodiments, at exchange 510, the location awareness module 218 may analyze the data received from the IPS beacons 104 to identify a user device identifier. For example, the location awareness module 218 may scan for registered phone MAC addresses.

In some embodiments, at exchange 512, the location awareness module 218 may transmit a notification to the notification engine 222 of registered user device identifiers. For example, the location awareness module 218 may notify the presence of registered user device identifiers (e.g., MAC addresses of user devices 106) to the notification engine 222. In some embodiments, the location awareness module 218 may also transmit to the notification engine 222 IPS beacon 104 identifiers in the proximity of the user device 106.

In some embodiments, at exchange 514, the notification engine 222 may query the user profile module 226 preferences of the identified user devices 106. The user profile module 226 may retrieve and transmit 516 data associated with the identified user device 106. In some embodiments, at exchange 518, the notification engine 222 may query the content module 224 for content associated with the IPS beacon identifier. In some embodiments, the notification engine 222 may query the content module 224 for content based upon multiple factors, which may include but are not limited to user preferences, time of day, day of week, analytic report data, and other types of information. In some embodiments, at exchange 520, the content module 224 may retrieve and transmit content to the notification engine 222.

In some embodiments, at exchange 522, the notification engine 222 may initiate a content notification by transmitting data to the cloud notification push server 112. In some embodiments, at exchange 524, the cloud notification push server 112 may transmit the notification associated with the identified content to the user device 106. In some embodiments, at exchange 526, the user device 106 may acknowledge the notification associated with the content and present the notification to the user. In some embodiments, at exchange 528, the user device 106 may retrieve the content responsive to a user responding to the notification, for example, by clicking hyperlink that may be included in the notification from the cloud notification push server 112.

Now referring to FIG. 5B, a flow diagram of a method for location based content delivery, in accordance with one or more embodiments of the disclosure, is depicted. FIGS. 5A and 5B are similar in many respects, thus only the differences are discussed in further detail. In some embodiments, at exchange 502, the user device 106 may transmit the data to the user profile module 226. The data transmitted to the user profile module 226 may include a user device identifier such as a MAC address of the user device 106. The data may also include preferences for content, such as an indication of an interest in food, sports, specific stores, etc. In some embodiments, at exchange 555, the user profile module 226 may then register the user device 106 with the cloud notification push server 112. In some embodiments, the user profile module 226 may directly register the user device 106 with the cloud notification push server 112 using identifying information from the user device 106 such as a user device identifier (e.g., MAC address of the user device 106). By registering the user device 106 with the cloud notification push server 112, the user profile module 226 may not need to notify the location awareness module 218 of the user device identifier, as depicted in FIG. 5A. Additionally, the location awareness module 218 may not need to analyze the data received from the IPS beacons 104 to identify a user device identifier (e.g., scan for registered phone MAC addresses) as depicted in FIG. 5A.

In some embodiments, a wireless network provider may provide one or more Internet or web portals where merchants or IPS subscribers may define their targeted messaging and/or content delivery needs. The merchant may log into the portal and define or select multiple parameters. For example, the IPS subscriber may specify a wireless access point in a specific location (e.g., select a particular IPS beacon 104). The IPS subscriber may select an existing access point (e.g., IPS beacon 104) or the IPS subscriber may submit a new access point location. For example, department store ABC Store located inside XYZ Mall may select a common wireless access point that is already publicly available (e.g., may be owned and managed by a third party), or the ABC Store may submit the access point installed inside its retail premise (e.g., privately owned and managed by ABC Store). For the third-party access point, that third party may provide authorization to all or specific parties to utilize their access points. For example, XYZ Mall may choose to allow all merchants to use its public access points, or XYZ Mall may select specific merchants, like ABC Store, to use them.

Another parameter that may be specified by an IPS subscriber is messaging procedures (e.g., types and frequency of notifications transmitted to user devices 106) corresponding to selected access point locations. For example, IPS subscribers may select pre-defined messages (e.g., “Welcome to MY_LOCATION,” where MY_LOCATION is dynamically generated based on the business name defined in the location database) or may define their own customized messages. For example, ABC Store may define or select a message that promotes its own products, or it may select to promote another merchant (e.g., “Get a free AMC pass when you buy Nike Flex.”).

Another parameter that may be specified by IPS subscribers is the frequency of the delivery of messages to the user devices 106. Each delivery of a message to a user device 106 may be considered an impression, similar to ad impressions on the Internet. When the user taps the user device 106 to open the message, then it may be considered as a “click-through.” After the IPS subscriber defines access points and messages corresponding to those access points, the IPS subscriber may select the frequency of delivery of messages. For example, the IPS subscriber may determine to target messages to every registered user device 106 that moves within the range of a given IPS beacon 104, provided the owner of that user device 106 has agreed and opted-in to receive communication on that device. The IPS subscriber may determine to target messages to every registered user device 106 at predetermined times or time intervals. The IPS subscriber may determine to target messages to certain registered user devices 106 in incremental sequence (e.g., every 5th device, every 10th device, or every 100th device). The IPS subscriber may determine to target messages to specific registered user devices 106 that are already known by the merchant or IPS subscriber. The merchant or IPS subscriber may, for example, collect the MAC addresses of user devices 106 during the opt-in process.

In some embodiments, the network provider may also define pricing schemes based on the above frequency of transmitted messages. Some illustrative examples may include: target all devices: $0.01 (impression), $0.02 (click-through); target every 5th device: $0.02 (impression), $0.04 (click-through); or target known devices: $1.00 (impression), $2.00 (click-through).

Another parameter that may be specified by an IPS subscriber may be payment associated with the frequency of transmitted messages. For example, the IPS subscriber may deposit (in prepaid or postpaid arrangement) a budget for messaging campaigns corresponding to the messages and their frequency as described herein. For example, ABC Store may create an advertising campaign with an allocated budget of $1,000 and target known devices (customers they already know). ABC Store would deplete its budget as soon as customer number 1,001 (based on $1 per known device model) walks into its store. The network provider may automatically suspend ABC Store's notification campaign when the budget is depleted.

In some embodiments, the network provider may be responsible for sending messages as defined by the merchants or IPS subscribers, as illustrated above. When a user device 106 is recognized by an IPS beacon 104, the location aware content server 108 may send messages based on the messaging definition specified by the IPS subscriber. The network provider may push messages to only those devices that have opted-in to receive notifications.

The network provider may provide notifications to user applications 206 that are authorized to receive such notifications. For example, a navigation application, such as Google Maps, may subscribe to the wireless network based on notifications enabled by the network provider. The network provider may share revenue with the navigation application for delivering location based advertisements.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method comprising:
receiving, by a content delivery system comprising one or more computers, data from one or more indoor positioning system (IPS) beacons;
determining, by the content delivery system, a location of a user device based at least in part on the received data;
retrieving, by the content delivery system, content based at least in part on the location of the user device; and
transmitting, by the content delivery system, a notification generated based at least in part on the retrieved content.

2. The computer-implemented method of claim 1, wherein the data further comprises information associated with the user device, the one or more IPS beacons, or an IPS local coverage area.

3. The computer-implemented method of claim 1, wherein retrieving the content further comprises:
retrieving, by the content delivery system, the content based at least in part on a user profile associated with a user of the user device.

4. The computer-implemented method of claim 3, wherein retrieving the content further comprises:
retrieving, by the content delivery system, the content based at least in part on the retrieved user profile.

5. The computer-implemented method of claim 3, further comprising:
transmitting, by the content delivery system, a plurality of notifications to the user device, wherein each of the plurality of notifications is transmitted at a frequency based at least in part on one of the retrieved user profile or a parameter specified by a merchant.

6. The computer-implemented method of claim 1, wherein the content is a coupon.

7. The computer-implemented method of claim 6, further comprising:
receiving, by the content delivery system from the user device, a request to redeem the coupon.

8. The computer-implemented method of claim 7, wherein the request to redeem the coupon is received via a redemption URL.

9. The computer-implemented method of claim 1, wherein the notification comprises a pre-defined message from a merchant.

10. The computer-implemented method of claim 1, wherein the data from the one or more IPS beacons comprises a MAC address associated with the user device.

11. A system comprising:
at least one memory storing computer-executable instructions; and
at least one processor, wherein the at least one processor is configured to access the at least one memory and to execute the computer-executable instructions to:
receive data from one or more indoor positioning system (IPS) beacons;
determine a location of a user device based at least in part on the received data;
retrieve content based at least in part on the location of the user device; and
transmit a notification generated based at least in part on the retrieved content.

12. The system of claim 11, wherein the data further comprises information associated with the user device, the one or more IPS beacons, or an IPS local coverage area.

13. The system of claim 1, wherein the at least one processor is further configured to execute the computer-executable instructions to:
retrieve the content based at least in part on a user profile associated with a user of the user device.

14. The system of claim 13, wherein the at least one processor is further configured to execute the computer-executable instructions to:
retrieve the content based at least in part on the retrieved user profile.

15. The system of claim 13, wherein the at least one processor is further configured to execute the computer-executable instructions to:
transmit a plurality of notifications to the user device, wherein each of the plurality of notifications is transmitted at a frequency based at least in part on one of the retrieved user profile or a parameter specified by a merchant.

16. The system of claim 11, wherein the content is a coupon.

17. The system of claim 16, wherein the at least one processor is further configured to execute the computer-executable instructions to:
receive, from the user device, a request to redeem the coupon.

18. The system of claim 17, wherein the request to redeem the coupon is received via a redemption URL.

19. The system of claim 11, wherein the notification comprises a pre-defined message from a merchant.

20. The system of claim 11, wherein the data from the one or more IPS beacons comprises a MAC address associated with the user device.
